(19) United States
(12) Patent Application Publication
(10) Pub. No.: US 2015/0317717 A1
(43) Pub. Date: Nov. 5, 2015

(54) COMPUTER AIDED SHOPPING WITH REVIEWS SYSTEM

(71) Applicant: Reela, Inc., New York, NY (US)

(72) Inventor: Edward Jason OLEBE, New Paltz, NY (US)

(21) Appl. No.: 14/610,928

(22) Filed: Jan. 30, 2015

Related U.S. Application Data
(60) Provisional application No. 61/987,703, filed on May 2, 2014.

(51) Int. Cl. G06Q 30/06; G06F 17/30; G06Q 30/02

(52) U.S. Cl. CPC G06Q 30/0627; G06Q 30/0256; G06Q 30/0639; G06F 17/30256

(57) ABSTRACT

The claimed system and method allows a user to set up a variety of preferences to receive information about products and services. In a store, a customer may select a product and the system may use those preferences to serve data that has been determined to be relevant to the users. The user may select a broadcast list to receive the request and the system may rank and sort the responses based on relevance to the specific user.

### BACKGROUND

Shopping in proximity to the product under purchase consideration has advantages and disadvantages. Being in proximity, a user may be able to physically observe and interact with an object and get a sense of the quality, fit, physical attributes and compatibility with other objects. In addition, the item may be immediately available and may be taken home the same day.

On the downside, it can be cumbersome to research a variety of products while using a portable computing device, such as a smart phone. The desired data may be dispersed over several sites, may not be trustworthy, may be too numerous to evaluate and/or may be obsolete. Further, the data may not be on point or may not be relevant. It would be useful to have a computer system that may be able to receive and sift data about a product or service, distill it down to a few key entries, promptly deliver it to customers in proximity to a product or service and display it in a simple, visual way.

Additionally, shopping online also has advantages and disadvantages. A user has access to a large set of information, products and services from which to choose and/or act upon. However, this set is still limited to what others have actively placed online and may not include items a seller has been unable or unwilling to place online. It would also be useful to have a service that would enable online buyers to access products and services that other users in proximity to such services placed online without requiring action by the seller.

### SUMMARY

The claimed system and method allows a user to set up a variety of preferences to receive information about products and services. In proximity, a customer may select a product and the system may use those preferences to serve data that has been determined to be relevant to the users. The user may select a broadcast list to receive the request and the system may rank and sort the responses based on relevance to the specific user. The responses may be from friends on or from a social computing network or may be from experts, some of whom expect to be paid for their knowledge. Users may have the ability to set up broadcasts lists and preferences in advance such that only desired audiences may be able to receive the requests for information. As a result, users in proximity may be able to promptly make more informed decisions based on valuable opinions from trusted sources. Audiences of the broadcast list may be able to negotiate for and purchase products and services from users that have selected products and services based on proximity.

### BRIEF DESCRIPTION OF THE DRAWINGS

FIG. 1 illustrates elements that make up one embodiment of the system;

FIG. 2 is high level process of identifying a product;

FIG. 3 is an illustration of requesting information on a good or service;

FIG. 4 is an illustration of identifying a product

FIG. 5 illustrates a process of broadcasting a request for information;

FIG. 6 illustrates a process of searching online for information related to the product;

FIG. 7 illustrates a process for processing responses of information;

FIG. 8 illustrates a high level view of the computing equipment and communication links;

FIG. 9 illustrates a mobile computing device; and

FIG. 10 illustrates a server computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

The disclosed system may assist users in obtaining information about a product through a portable computing device while in a store or in proximity to a good or service or while considering a purchase of a good or service. In the past, users had to do research remotely and ahead of time and the research took time to sift. The sifting was especially difficult in a store or in proximity to a good or service as portable computing devices often have small displays and challenging user input features. For example, a user might scan in a bar code of an item but the review information received on the item was not specific to the user and there is no way to tell if the review information is reliable of unreliable. In the claimed system, a requestor may request information on a product using a portable computing device 104 and a variety of sources and responders may provide useful information in response which may be sifted to be specific to the desires of the user.

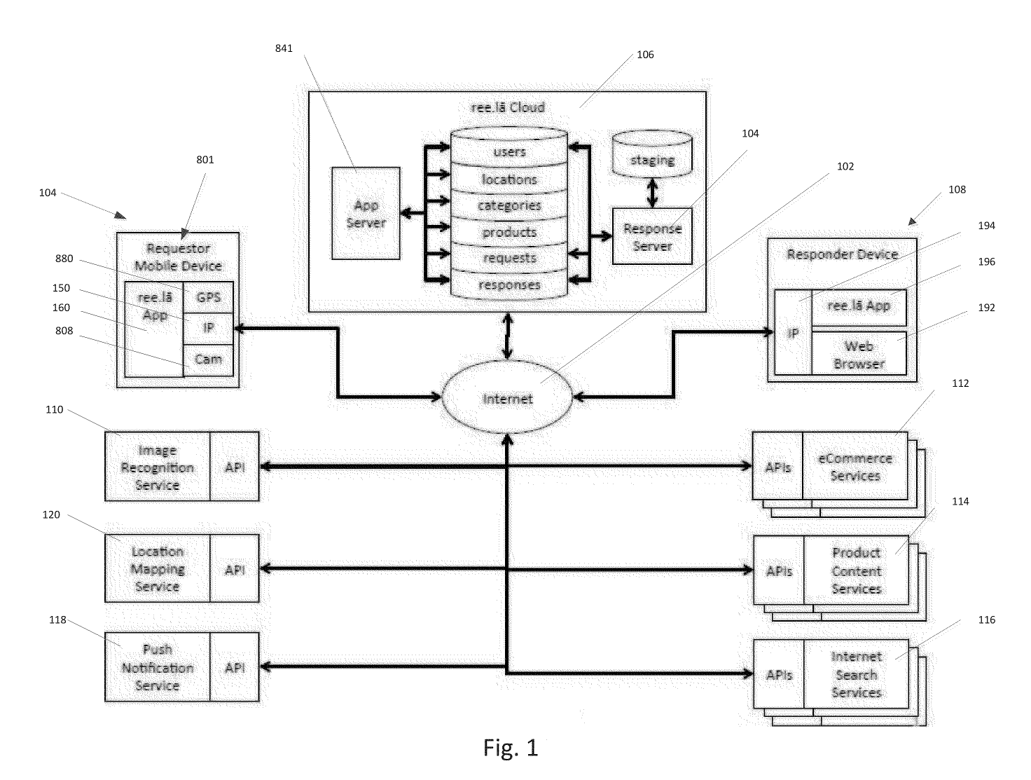

FIG. 1 may be a first illustration of some of the computing components which may be part of the system. In some embodiments, the computing components may be physically configured specifically for the task. In other embodiments, the steps may performed as a process that is used to instruct a processor. Of course, a combination of physical parts and applications may be used as part of the system and the method.

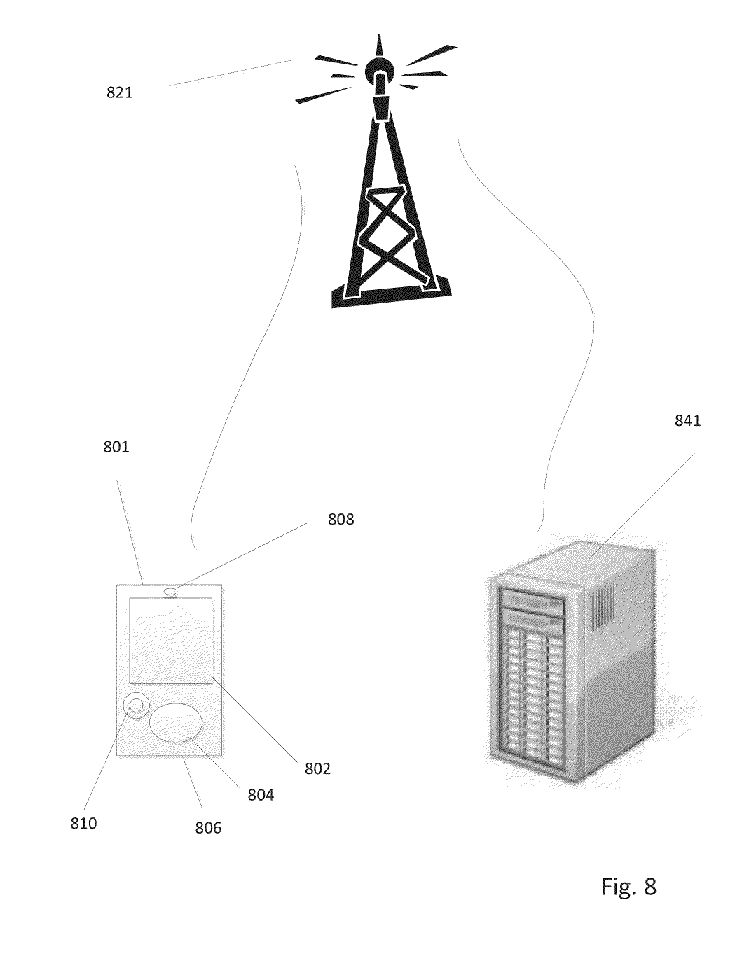

A communication network 102 may be at the center of the system. The communication may be wired or wireless or a combination of the two. For example, a portable computing device 801 (FIG. 8) may be a smart phone and the smart phone may have an application that physically configures the processor in the smart phone to execute part of the method. A requesting user 104 may use a portable computing device 801 to make an inquiry about a good or service and a responder 108 may use a portable computing device 801 to provide a response. The portable computing devices 801 may communicate wirelessly to a cloud of computers 106 that collect and process the data from the various sources such as responders 108 who may also use portable computing devices 801.

The cloud of computing devices such as server type 841 (FIG. 8) devices may have a variety of applications and data which may be accessed and used as part of the system. The system may use an image recognition service 110 to assist in recognizing item (or a symbol representing the item or service), an eCommerce service 112 to enable electronic commerce or retrieve additional product information, product content services 114 to enable obtaining more information about the good or service, internet search service 116 to enable prompt searches of internet sites to obtain information about the good or service, push notification services 118 to enable notifications and requests for information to be push to users and contributors, and location mapping services 120 to enable placement of the user and portable computing device in space such that additional information about the good or service may be obtained.

An application cloud 106 may also collect, store and sift information obtained and created related to goods and services. For example, the cloud service 106 may include information on users, locations, categories, products, past requests and past responses. In this way, common searches may be stored and data on commonly queried categories or products may be stored and quickly retrieved. As a more specific example, if a user is mapped as being in a cellular telephone store, the number of relevant categories may be reduced as cellular telephone stores may only sell a limited number of good or services. Further, past requests from the cellular telephone store may be located along with past responses such that quick responses may be created depending on the request of the user. As will be further explained, an app server 841 may exist to sift all the information and promptly respond with the information that is determined to be most useful for the specific user.

The requestor may use a mobile device 801 (FIG. 8) which may also include additional useful functionality. Logically, it may include global positioning system (GPS) equipment 880 (FIG. 8) such that the device location (and likely user location) may be determined and an image sensor 808 such as a camera such that images may be electronically captured. The mobile computing device 801 may also have an internet protocol application 150 such that the images and related data may be efficiently and reliably communicated to the cloud or to other services accessible over commonly available networks like cellular networks and WiFi networks, for example, and not limitation. An application 160 that enables the system may also execute on the mobile computing device as it may physically configure the processor to enable the requestor to request information. In other words, the back end servers may have a variety of roles in the system as may the portable computing devices as each may perform more or less of the steps in the system. Logically, a responding device 108 may also have a web browser 192, an IP protocol 194 application to enable efficient and secure communication and an app 196 to enable a responder to create responses.

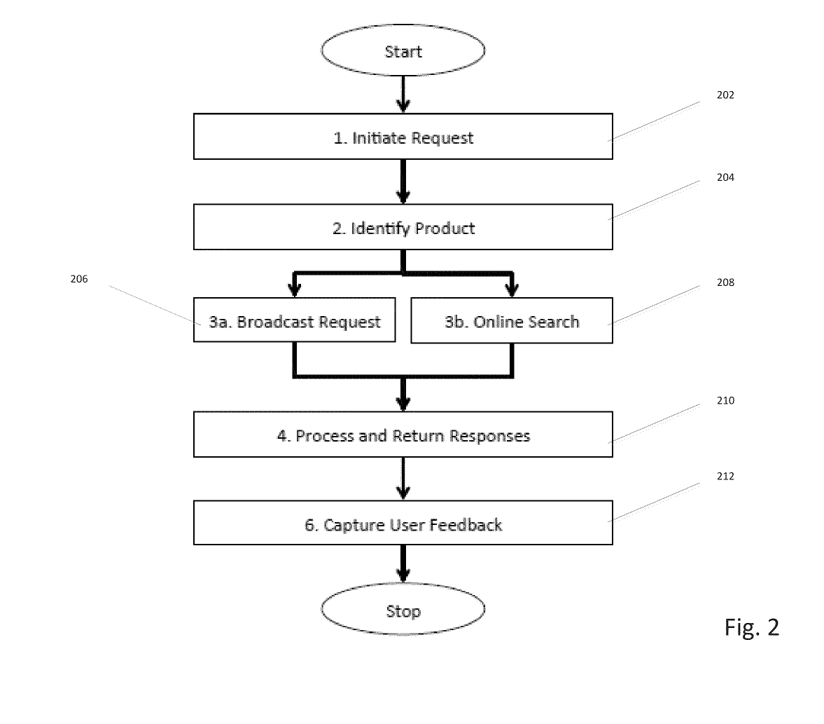

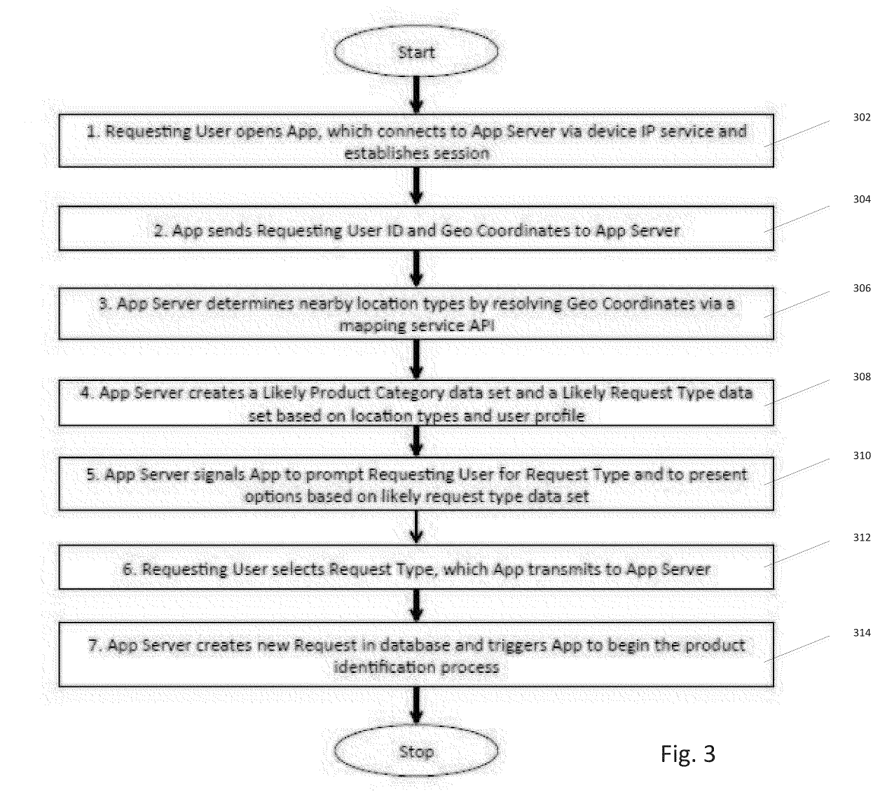

Referring to FIG. 2, a user may start the process of attempting to obtain relevant additional information about a good or service. At block 202, a user or requestor 104 may initiate a request for additional information about a good or service. The request may be made on a portable computing device 801 that may communicate through a communication system 102 such as a cellular system or a Wifi system or a combination of communication systems where the request may be received by a cloud based system. More information on starting the process may be disclosed in relation to FIG. 3.

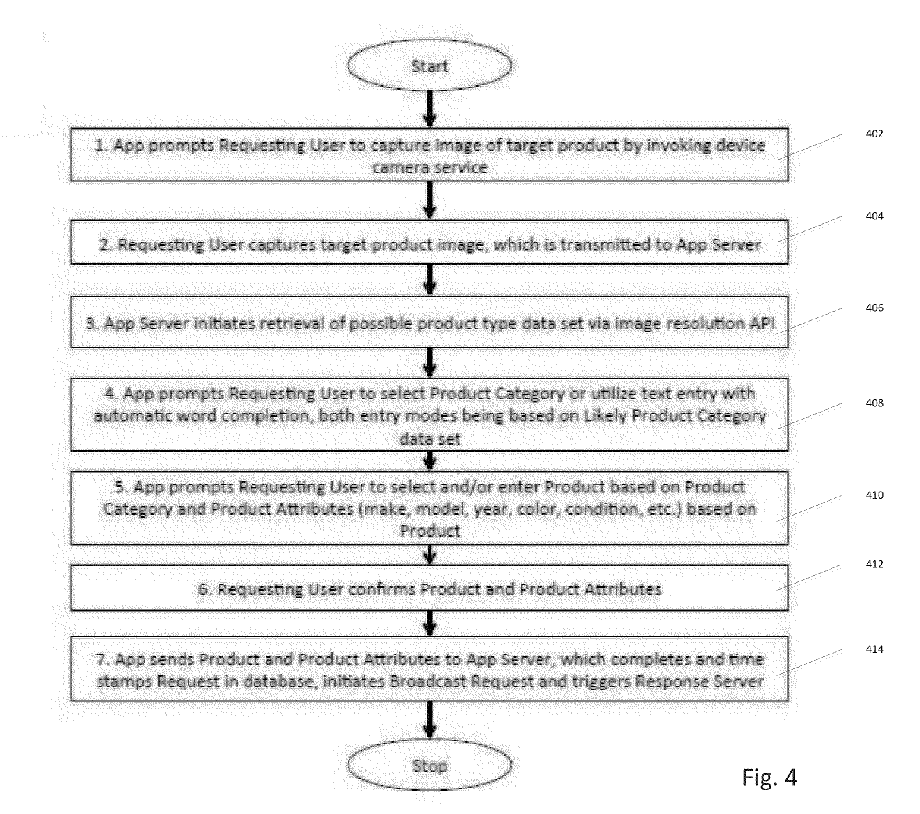

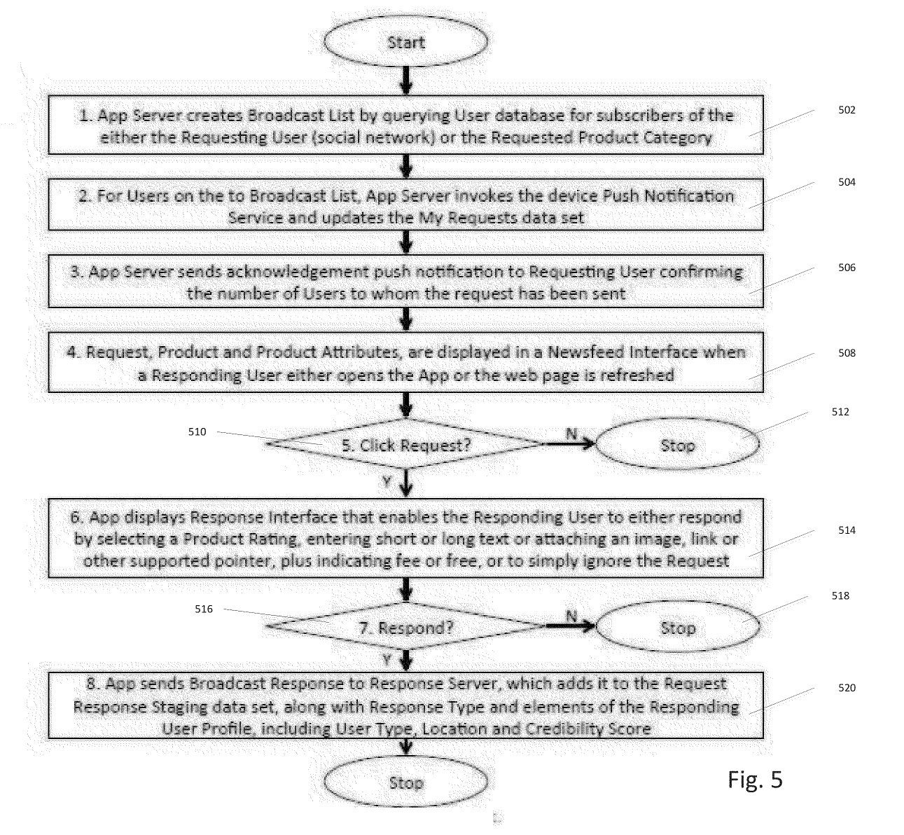

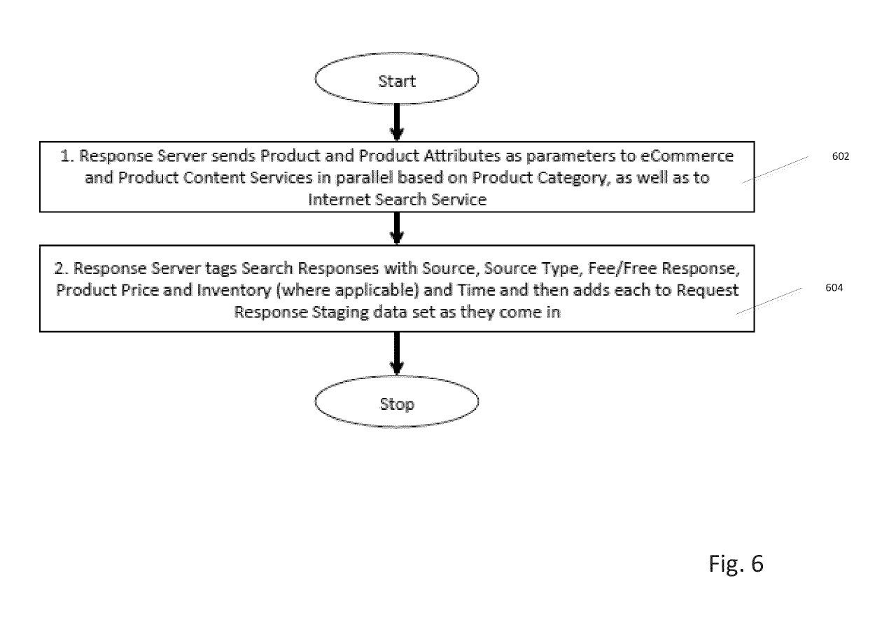

At block 204, the system may attempt to identify the good or service to be reviewed. FIG. 4 may present a more detailed methodology for identifying the good or service. In some embodiments, the good or service may be easy to identify and in other situations, the good or service may be more of a challenge to properly identify. At block 206 and 208, attempts may be made to gather relevant information on the goods or services. In block 206, a broadcast may be initiated by the app server 100 to solicit feedback from users or experts. FIG. 5 may explain in more detail the process of obtaining feedback. At block 208, the app server 841 may search for relevant information from web sites or similar network locations. FIG. 6 may illustrate additional steps involved in searching for relevant information.

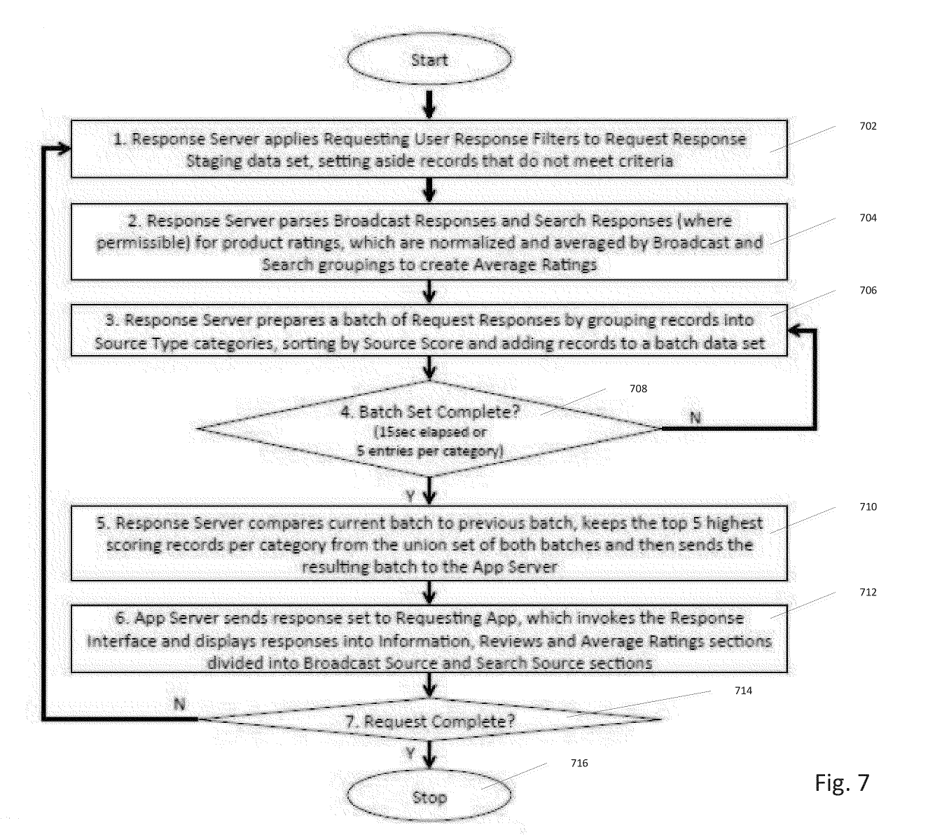

At block 210, the information returned from searches and individuals may be analyzed and processed. FIG. 7 may further illustrate the analysis process. At block 212, the feedback from a user may be captured. The feedback may include whether the information supplied was useful or whether the information was not as desired. In the future, useful information may be supplied to similar queries and undesired information may not be supplied to similar queries.

Referring to FIG. 3, additional detail of the process of starting the system may be disclosed. At block 302, a requesting user 104 may open an application 160 (app) on a computing device such as a portable computing device 801. The app 160 may connect through a variety of communication forms 102 such as WiFi, near field communication, cellular communication, etc., to the app service which may be operating on one or more servers 841 which may make up a computing cloud 106. Assuming the connection between the app 160 and app server 841 has been made, a session may be established between the app 160 and the app server 841. The data may be encrypted or otherwise safeguarded to avoid an undesired disclosure of potentially private data. Of course, the app may be local or may take the form of a web site that is accessed by a user and which may have functionality similar to the app.

At block 304, the app 160 may communicate a requesting user id and geographic coordinates to the app server 841. The user id may be set up in advance or during the session. As part of the user id set up, a user may be asked a series of questions which may help filter the results. For example, the user id may indicate that a user is an experienced shopper that is primarily interested in the best item available in a category while another user id may be set up to indicate the user has little use for so called experts but heavily relies on consumer feedback collection sites such as Consumer Reports. Additionally, these preferences may be set by request type, product category, product, time of day, geography or other attributes of purchase scenarios.

Geographic location may be used to further narrow down the category of goods that a user may desire. For example, a user in a grocery store is likely looking for food and not auto parts. Geographic coordinates may be obtained in a variety of manners. In one embodiment, a portable computing device may including GPS 880 capability to report a user location. In another embodiment, WiFi in known locations may be used to establish a location. In yet another embodiment, a portable computing device 801 may have additional locational circuitry such as Bluetooth or iBeacon which may be received in known locations and used to establish a location of a user. Of course, all these locational technologies may be used alone or together in various manners to help narrow down the location of a user.

At block 306, the app server 841 may determine nearby location types. An API to a mapping service 120 may be used to determine the nearby location types. For example, the latitude and longitude of a user may be communicated to an API and the mapping application 120 may respond with the types or categories of businesses that are closest to the latitude and longitude. Similarly, other locational data may be communicated to the API and the mapping service 120 may be able to translate the locational data into the desired location types.

At block 308, to speed responses and limit data, the app server 841 may use the location types and user profile to create likely product category data sets and likely request type data sets. As previously mentioned, a user may set up a profile in advance and the profile may list items of interest to the user. As a result, items of interest may be added to a likely request category or data set and items not of interest may not be added to a likely request category or data set. Similarly, the location type may be used to help limit down the logical data. For example, it is unlikely food would be for sale at an auto parts store.

At block 310, the app server 841 may communicate to the app 160 on the portable computing device 801 to enter a request type. In some embodiments, the list of narrowed request type as determined in block 308 may be communicated to assist the user in selecting a request type, for example, price comparison, opinions from friends, ratings only, etc. The user may type in the request type, may select from a drop down list of request types or a combination of the various ways of entering a request type. At block 312, the request type may be communicated from the app 160 to the app server 841. At block 314, the app server 841 may user the request type to begin a product identification process as the request type may limit the amount of data that has to be searched.

There may be several users that use the same app or there may be several aliases that use the same app and preferences may be created for each alias or user. As a result, combined decisions may be possible. For example, a user may be able to select the members of a family and the app may be able to select a dinner item that is most likely to appeal to an entire family by using the preferences for the various family members from their accounts. Similarly, other users may allow their preferences to be known and a user may be able to select items most likely to appeal to the additional users by accessing (anonymously or with permission) the attendees accounts. As yet another example, people planning to attend a dinner party may make their preferences known and the user may be able to select a dinner that is most likely to please the dinner party. In yet another aspect, a user may have several accounts such as “weekend me” or “vacation me” or “work me” each of which may have different preferences.

FIG. 4 may illustrate one of the many possible manners of identifying a product. At block 402, the app 160 may prompt the use to capture an image of the target product. The prompt may be in a variety of formats, including an image on the display 802, a sound, a vibration, etc. The image may include a shape or images to assisting in aiming the image capture device. At block 404, the captured image may be communicated to the app server 841. As mentioned previously, the communication of the image may be in a variety of formats. For example, in order to save bandwidth, if an id code is located on the item, only the id code may be communicated as the id code may be the only item needed to identify the good.

At block 406, the app server 841 may narrow down the possible good or service types based on an analysis of the image. The analysis of the image may be local on the user device 801 or may be remote. A separate app 110 may be used to help in identifying the good or service in the image. For example, the separate app 110 may be a pre-existing app that is modified to specifically look for goods or services in certain request types. At block 408, the app may prompt the user to select a product category based on the likely product category data set. The prompt may be based on what the system has learned from previous requests from similar users in similar locations. The prompt may also utilize an automatic completion interface where the user begins to type information and the app completes the entry based on what the system has learned from contextual information derived locally on the device or from the app cloud system.

Once the product category has been selected, at block 410 the app 160 may prompt the user to enter a product. The product options available may be limited based on the product category and the product attributes. For example, if the product category is postal supplies, it will be unlikely that a user could be considering purchasing a hair brush but it would be likely that the user is considering buying stamps. The product may have additional information such as make, model, year, color, condition, etc., based on the product. At block 412, the system may ask that the user confirm the product and product attributes through an interface that automatically completes text entries or presents selection options based on what the system has learned about the user, the context and/or other gathered attributes by analyzing previous requests. Finally, at block 414, the system 106 may receive the product and product attributes as approved by the user which may be stored in a memory along with a received time. A broadcast request may be promptly generated and the response server 104 may be triggered and is further described in FIG. 5.

FIG. 5 may illustrate one manner of broadcasting the request for additional information on the good or service. At block 502, the app server 841 may create a broadcast list. The broadcast list may be generated in a variety of ways. In some embodiments, the user profile may be used to assist in creating the broadcast list. For example, some users may just want input from their social network friends when trying on clothes while other users may want input from experts when buying a car.

At block 504, once the broadcast list has been created, the app server 841 may invoke a push notification service to obtain information from the desired social network or experts. In addition, the notification may be saved in a memory for future use by the system. For example, if a user requests information on a 2015 Corvette, the located information may be valuable to future users that request information on a 2015 Corvette.

At block 506, the app server 841 may inform or confirm to the user that the request has been communicated to the desired audience. In some embodiments, the number of people or sources that received the request may be disclosed. At block 508, the app server 841 may communicate the request, product and product attributes in a newsfeed to responding users. At block 510, it may be determined whether the responding user 108 selected to view the request.

The responding user 108 may ignore the message and the system may stop for that responding user at block 512. If the user selects the request, at block 514, an interface may be displayed to the responding user 108 that may allow the responding user to enter a rating, a long text, a short text, attach an image, link to another site, indicate whether the response is free or if there is a cost, etc. At block 516, the system may determine if the responding user 108 decided to respond. If the responding user 108 declines to respond, at block 518, the system may end.

If the responding user 108 decides to respond, at block 520 the system may communicate a broadcast response to the response server 104. In the response server 104, the response may be added to the response staging data set, along with the response type and elements of the response user profile, including such information as user type, location and credibility score.

Also, as the request is broadcast to a group of people, other users may want to buy or bid on the product in question. As an example, a requestor 104 may request information on an antique car. The photo of the car may be communicated to a variety of responders 108. The responders may be interested in buying the car. In this case, the response from the responders 108 may include bids for the good or service. Thus, the request for information may create a new marketplace for goods and services as the mere request for additional information may entice bids for the good or service in question.

In some embodiments, there may be a dedicated manner to advertise goods and services for sale. For example, instead of appearing as a request for reviews, the communication may appear as a request for bids or as an offer for sale. The communication may use a different “channel” as opposed to the “seeking review” channel. In this way, requestors and responders may opt in to receive such communications. In addition, the channel may be set up to run an auction, including receiving bids, setting a time limit, informing bidders of other bids, accepting payment, arranging for delivery, etc. Of course, an auction is just one format as a traditional offer and response may be appropriate.

The requestor 104 may also be able to create, modify or delete a broadcast list. For example, a requestor 104 looking for comments on a swim suit may want to limit the broadcast list to close friends. Similarly, a requestor 104 looking for comments on a computer may wish to add in computer experts to the broadcast list. Logically, the broadcast list may be modified in advance or while in physical or temporal proximity to the product or service.

FIG. 6 may illustrate an online search in response to a user query. At block 602, the response server 104 may communicate the product and product attributes as parameters to an eCommerce 112 and product content service 114. The search may be based on the product category, for example, In addition, the search may be communicated to an internet search service 116. At block 604, the response server 104 may tag the returned search responses with a variety of tags such as source, source type, fee/free response, product price, and inventory (if applicable) and time. The responses may then be added to a request response staging data set as they arrive. As mentioned previously, the response staging data set may be analyzed before responses are communicated to the user.

Referring to FIG. 7, response processing may be described. At block 702, the response server 104 may apply a requesting user 104 response filter to the received response data to set aside the records that do not meet the user criteria. For example, if a user 104 is trying on clothes, the user 104 may only want to hear from social network type friends and responses from professionals may be set aside.

At block 704, the response server 104 may parse the responses for product rating. The product ratings may be normalized and averaged by broadcast response ratings and search response grouping to create average ratings. As an example, 4 out of 5 stars may be normalized into 8 out of 10 starts. Similarly, the broadcast ratings and search ratings may vary widely such each group may be averaged. At block 706, the response server may create a batch of request response by grouping records into source type categories, where the responses are sorted by source score and adding the responses to a batch data set.

At block 708, it may be determined if the batch set is complete. The determination may be made on a variety of grounds. In one embodiment, the batch may be considered complete if there has been a 15 second lapse of time since an additional response. Another ground may be that five entries have been received per category. Of course, other thresholds may be used to determine that a batch is considered complete. If the batch is not considered complete, the system may return to block 706 and obtain more request responses. If the batch is considered complete, the system may proceed to block 710.

At block 710, the response server 104 may compare the current batch of responses to previous responses. In one embodiment, the top five scoring responses per category from the union of both batches may be communicated to the app server 841 as a response set. At block 712, the app server 841 may communicate the response set to the requesting app 160. The requesting app 160 may execute the response interface and may display responses into sections such as information, reviews, average ratings within each section containing information separated by broadcast sources and search sources. Both the selection of responses to forward by the app server and the method by which responses are displayed on the requesting app may be informed by what the system has learned about the user, context or other attributes gathered by similar requests, responses, users, products and contexts, including but not limited to the amount of time elapsed since the request, the display capabilities of the requesting device, the bandwidth of the connection between the app and the app server, etc.

The learning aspect of the system may occur in a variety of ways including using neural network type learning by sifting past query data, responses and reviews of the responses. In some embodiments, the system may review past queries for a user and if a query is close, details from the previous query may be used. As an example, if a query contains an image of a shoe and the user has made a majority of queries about Nike® shoes, the system may infer that the present query is about Nike® shoes. In another embodiment, the comparison may be broader as other users may be anonymously be reviewed and users that have a similar query history may be used to make predictions about future queries for the first user. As an example, if an additional user has a similar history of queries regarding Nike® shoes and Apple® computers, a query from a first user (that has a history of Nike® queries) about computers may be determined to likely be about Apple® computers. Of course, both personal query histories and query histories of others may be used in combination to make assumptions about a product or about whether a particular good or service may be desirable for a particular user.

At block, 714, the system may determine if the request is complete, such as the user closed the app or otherwise indicated that the search is complete. If the search is not complete, the system may return to block 702 and iterate through more user responses. If the search is complete, the system may end.

In some embodiments, the app server 841 may communicate with the user app 160 that feedback information may be helpful. For example, if an expert 108 responded and supplied a response, it may be useful to determine whether the response was useful to the requestor 104. The feedback data may be stored in a memory and may be supplied in future responses to assist requestors 104 in determining whether the responding data should be trusted.

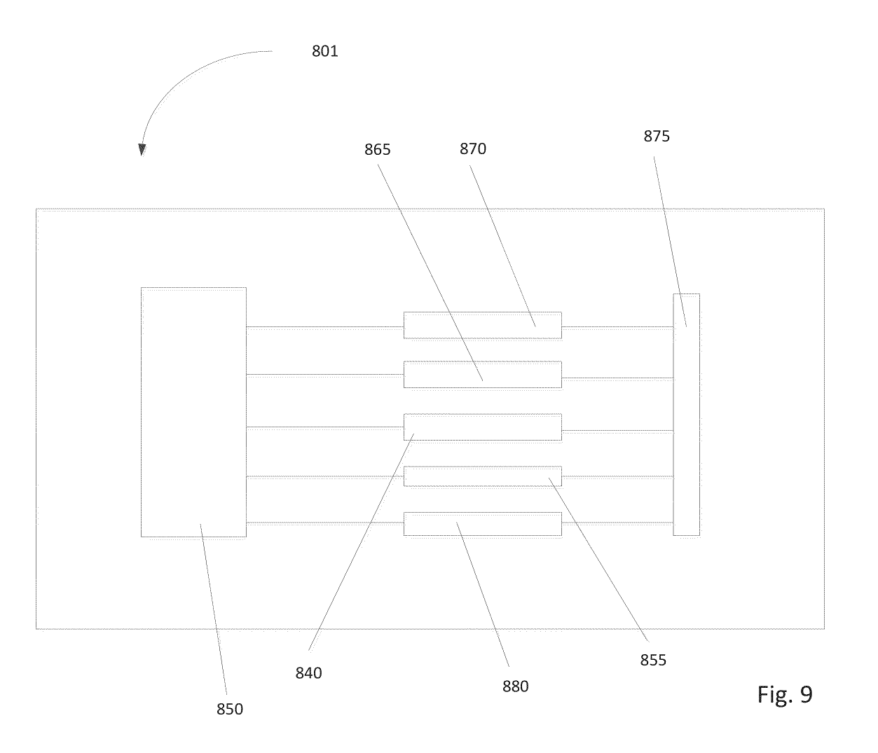

FIG. 8 may be a high level illustration of some of the elements a sample computing system that may be physically configured to implement the method and system. The computing system may be a dedicated computing device 841, a dedicated portable computing device 801, an application on the computing device 841, an application on the portable computing device 801 or a combination of all of these. FIG. 9 may be a high level illustration of a portable computing device 801 communicating with a remote computing device 841 but the application may be stored and accessed in a variety of ways. In addition, the application may be obtained in a variety of ways such as from an app store, from a web site, from a store WiFi system, etc. There may be various versions of the application to take advantage of the benefits of different computing devices, different languages and different API platforms.

In one embodiment, a portable computing device 801 may be a device that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

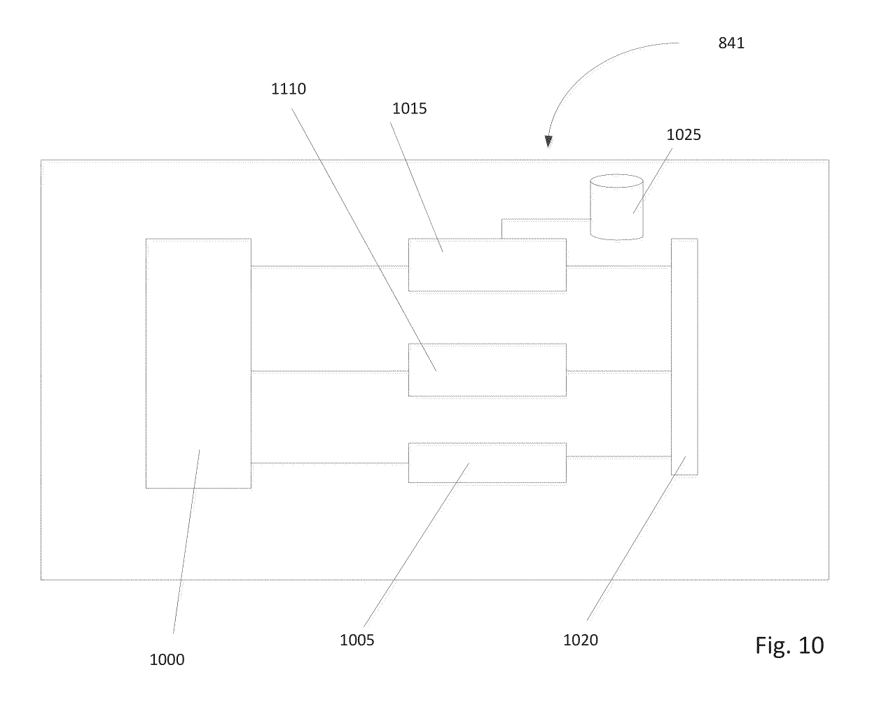

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 9 may be a simplified illustration of the physical elements that make up a portable computing device 801 and FIG. 10 may be a simplified illustration of the physical elements that make up a server type computing device 841.

FIG. 9 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs 802, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 10. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs 802, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving visual display. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A method of delivering useful data to a portable computing device comprising:
receiving an image representing a good or service from a user;
analyzing the image to recognize the specific type of image;
if the image is not recognized, communicating the portable computing device that the image was not recognized;
if the image is recognized,
determining a classification of the image;
obtaining information about the image from a plurality of sources;
determining the identity of the user;
determining the preset preferences of the user;
applying the preset preferences of the user based on the classification of the image to score the information about the image from the plurality of sources;
communicating the information about the image from the plurality of sources with a score over a threshold to assist the user in a purchase.

2. The method of claim 1, further comprising obtaining feedback on previous searches.

3. The method of claim 1, wherein responses from the plurality of sources may require money to see a response.

4. The method of claim 1, wherein past queries are used to make predictions about future queries.

5. The method of claim 1, wherein queries for information on a good or service create a sale event for the good or service.

6. The method of claim 1, wherein the user is in proximity to a good or service.

7. A portable computing device comprising:
a power source;
an input output circuit;
an electronic display in communication with the input output circuit;
a memory;
a processor in communication with the memory wherein the processor is physically configured to execute computer instructions to:
capture an image representing a good or service from a user;
communicate the image to a remote server wherein
receiving on the portable computing device a notice that the image was not recognized if the image is not recognized at the remote server;
at the portable computing device, if the image is recognized at the remote server, receiving the information about the image from a plurality of sources with a score over a threshold to assist the user in a purchase wherein the information about the information comprises information from:
determining a classification of the image;
obtaining information about the image from a plurality of sources;
determining the identity of the user;
determining the preset preferences of the user; and
applying the preset preferences of the user based on the classification of the image to score the information about the image from the plurality of sources.

8. The portable computing device of claim 7, wherein the processor is further physically configured to obtain feedback on previous searches.

9. The portable computing device of claim 7, wherein the processor is further physically configured to require money to see a response from the plurality of sources.

10. The portable computing device of claim 7, wherein the processor is further physically configured to use past queries to make predictions about future queries.

11. The portable computing device of claim 7, wherein the processor is further physically configured to use queries for information on a good or service create a sale event for the good or service.

12. The method of claim 1, wherein the processor is further physically configured to determine if the user is in proximity to a good or service.

13. A computing device comprising:
a power source;
an input output circuit;
an electronic display in communication with the input output circuit;
a memory;
a processor in communication with the memory wherein the processor is physically configured to execute computer instructions for:
receiving an image representing a good or service from a user;
analyzing the image to recognize the specific type of image;
if the image is not recognized, communicating the portable computing device that the image was not recognized;
if the image is recognized,
determining a classification of the image;
obtaining information about the image from a plurality of sources;
determining the identity of the user;
determining the preset preferences of the user;
applying the preset preferences of the user based on the classification of the image to score the information about the image from the plurality of sources;
communicating the information about the image from the plurality of sources with a score over a threshold to assist the user in a purchase.

14. The computing device of claim 13, further comprising obtaining feedback on previous searches.

15. The computing device of claim 13, wherein responses from the plurality of sources may require money to see a response.

16. The computing device of claim 13, wherein past queries are used to make predictions about future queries.

17. The computing device of claim 13, wherein queries for information on a good or service create a sale event for the good or service.

18. The computing device of claim 13, wherein the user is in proximity to a good or service.
